(19) United States
(12) Patent Application Publication
(10) Pub. No.: US 2026/0180928 A1
(43) Pub. Date: Jun. 25, 2026

(54) BUILD AND VALIDATION OF CHATBOT SCHEMA USING MACHINE LEARNING

(71) Applicant: MICROSOFT TECHNOLOGY LICENSING, LLC., REDMOND, WA (US)

(72) Inventors: ALEXANDER OSTRIKOV, TEL AVIV (IL); ROTEM RINA PREIZLER, KIRYAT-ONO (IL); ALEXANDER TSVETKOV, TEL AVIV (IL)

(21) Appl. No.: 18/990,500

(22) Filed: Dec. 20, 2024

(51) Int. Cl. H04L 51/02; G06F 40/30

(52) U.S. Cl. CPC H04L 51/02; G06F 40/30

(57) ABSTRACT

A framework is provided to develop and validate a schema for a chatbot. The chatbot schema is automatically generated from a natural language description of the chatbot using machine learning models without user intervention. The chatbot schema contains machine-generated topics that are derived from simulated conversations generated by a language model. Trigger phrases and dialog flows are generated by the language model and input into the chatbot schema. The chatbot schema is then validated to identify any potential errors. The construction and validation of the chatbot schema in this manner enables developers of any skill level to quickly build a chatbot application.

### BACKGROUND

A chatbot (i.e., conversational bot, virtual assistant) is a computer program that interacts with a user, in natural language text or voice, to process the user's query. Many businesses use a chatbot on their websites to answer common queries and to connect with their customers in a personal way. Chatbots are advantageous since they help customers find information quickly by instantly responding to requests without human intervention. Chatbots are available around the clock, giving customers access to information at any time. They respond quicker than a human agent, often providing a response in a few seconds.

Chatbots typically rely on a set of predefined responses to answer a user's query. They follow a scripted conversation flow and interact with an end user with responses to anticipated queries that were programmed by a developer. Chatbots perform well when the user's query is understood and the answer is known. However, the design and development of a chatbot is challenging for dynamically-generated conversations that are not readily understood or anticipated by the chatbot and for which a pre-scripted response is not available.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A chatbot designer system provides a developer with a schema for a chatbot automatically from a natural language description of the chatbot that the developer wants to build. The chatbot schema defines the behavior of the chatbot from understanding an end user's query, to gathering more information from the end user, and to generating a response to the end user's query. The chatbot schema contains machine-generated topics having triggers and dialog flows that are used by a chatbot engine to converse with the end user. The topics are derived from simulated conversations generated by a machine learning model. Triggers and dialog flows are generated by the machine learning model and input into the chatbot schema. The chatbot schema is then validated to identify potential errors. The construction and validation of the chatbot schema in this manner enables developers of any skill level to quickly build a chatbot application.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram of a chatbot designer that generates an AI-developed chatbot schema.

FIG. 2 illustrates an exemplary system that utilizes the chatbot designer to build and verify a chatbot schema using machine learning.

FIG. 3 is a schematic diagram illustrating the components of an automated chatbot schema builder and an automated chatbot schema validator.

FIG. 4 is a flow chart illustrating an exemplary method for building a chatbot schema.

FIG. 5 is a flow chart illustrating an exemplary method for validating the operation of a chatbot using the chatbot schema.

FIGS. 6A-6D are schematic diagrams illustrating exemplary model inputs and model responses.

FIGS. 7A-7B are schematic diagrams illustrating an exemplary chatbot schema.

FIG. 8 is a block diagram illustrating an exemplary operating environment.

### DETAILED DESCRIPTION

### Overview

The subject matter disclosed pertains to an automated system for generating a chatbot schema from a natural language description of a chatbot. The chatbot schema outlines a structured conversation with a user that includes how the chatbot recognizes and interprets an end user's query or input and the actions the chatbot performs to generate a response to the end user's input. The chatbot schema is automatically generated for a developer given a natural language description of the chatbot and the chatbot's instructions. The chatbot schema is then used to guide a conversation with the user during the execution of the chatbot.

The chatbot schema consists of topics, where each topic represents a category of a conversation that pertains to the objective of the chatbot. The objective of an exemplary chatbot may be to assist customers of a bank with the services provided at the bank's website. A topic contains a trigger and a dialog flow. The trigger identifies a topic from the end user's input. The dialog flow contains actions that define how the chatbot responds to an end user input, such as generating questions to obtain information and generating responses depending on the conversation context.

Building a chatbot can be difficult, time consuming and error prone for a developer since conversations, by nature, are dynamic. Natural language is difficult to understand since it is complex, vast and ambiguous. A developer has to anticipate and prepare for unexpected user input which is not always possible. Machine learning models, trained on a large corpus of natural language, are better at understanding natural language since they can analyze vast amounts of text data and identify patterns and relationships between words and phrases, thereby learning to adapt to the complexities of a natural language through the model's vast exposure to diverse contexts.

In particular, the technique described herein uses machine learning models to generate the topics for a chatbot, the triggers of a topic, and the actions that define the dialog flow for each topic. In this manner, the automation of the development of the chatbot schema enables a developer to quickly build a chatbot which is advantageous for developers who have limited expertise or skill in creating a chatbot.

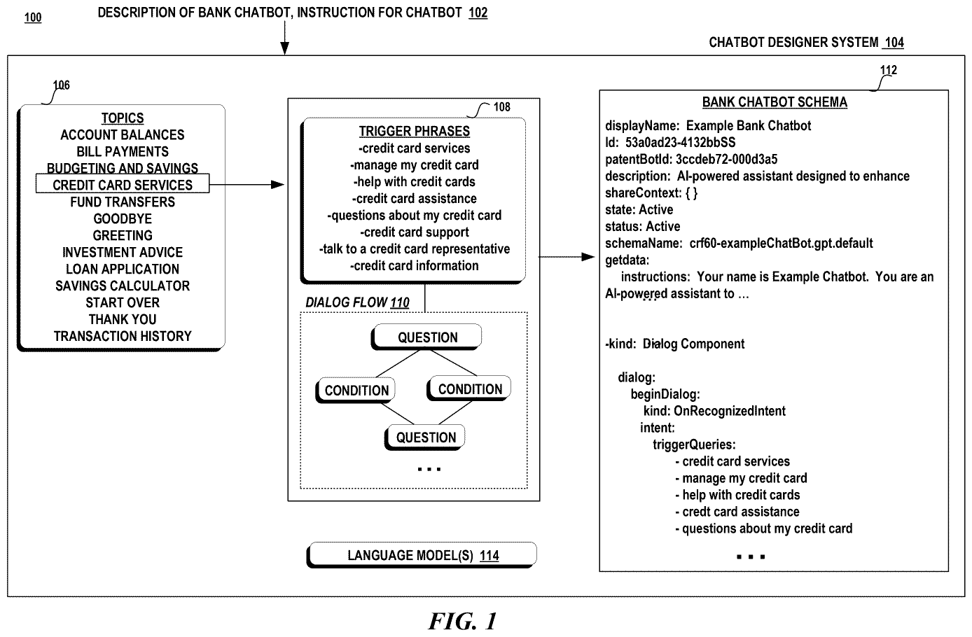

Turning to FIG. 1, there is shown a schematic illustration of a chatbot designer system 100. A developer may interact with a chatbot designer system 104 to create a particular chatbot using one or more language models 114. The developer provides the chatbot designer system with a description of the chatbot and the instructions for the chatbot in natural language text 102. The chatbot description is for the chatbot designer system to understand what the developer wants and the chatbot instructions are for the chatbot to understand its role.

For example, a developer may want to generate a chatbot for a bank's website. The developer may input the following description of the chatbot that the developer wants to build:

“The Example Bank ChatBot is an intelligent, conversational assistant designed to enhance customer experience and streamline banking operations. Leveraging advanced AI and machine learning technologies, this Example Bank ChatBot provides personalized financial guidance, efficient customer support, and seamless transaction management.”

The developer may also generate the following chatbot instruction:

“Your name is Example Bank ChatBot. You are an intelligent, conversational assistant designed to enhance customer experience and streamline banking operations at Example Bank. You provide personalized financial guidance, efficient customer support, and seamless transaction management using advanced AI and machine learning technologies. Analyze customer spending patterns, savings, and investments to provide tailored financial recommendations. Offer budgeting tips, saving strategies, and investment opportunities based on individual financial goals. Respond to customer inquiries about account balances, transaction histories, loan applications, and credit card services. Provide 24/7 support for common banking tasks, ensuring quick and accurate assistance. Escalate complex issues to human representatives when necessary. Facilitate secure and quick transactions, including fund transfers, bill payments, and mobile check deposits. Ensure all transactions comply with Example Bank's security protocols. Sync with other financial tools and services offered by Example Bank to provide a unified platform for managing finances. Assist customers in setting and tracking financial goals, offering reminders and progress updates. Provide access to detailed financial reports and analytics. Educate customers on best practices for maintaining their account security. Maintain a friendly, professional, and empathetic tone in all interactions. Adapt responses based on customer preferences and communication styles. Encourage feedback to continuously improve the service. Learn from customer interactions to enhance the accuracy and relevance of responses. If the user asks for legal advice, decline to assist and offer to help the user with other questions.”

The chatbot designer system 104, given the developer-provided description and instructions 102, automatically generates topics for the chatbot schema using a language model. The topics are categories of conversations that an end user may initiate with the chatbot. A more detailed description of the generation of the topics is found below.

As shown in FIG. 1, the topics for the bank chatbot include Account Balances, Bill Payments, Budgeting and Savings, Credit Card Services, Fund Transfers, Goodbye, Greeting, Investment Advice, Loan Application, Savings Calculator, StartOver, Thank You and Transaction History.

For each topic, the chatbot designer system 104 generates a trigger 108 using a language model. A trigger 108 responds to a triggering event such as an input from an end user (e.g., trigger phrase) or an event in a dialog flow. A trigger includes a trigger phrase. For the Credit Card Services topic, the triggers include trigger phrases, such as, “credit card services,” “manage my credit card,” “help with credit cards,” “credit card assistance,” “questions about my credit card,” “credit card support,” “talk to a credit card representative,” and “credit card information” 106.

The chatbot designer system 104 also automatically generates a dialog flow 110, using a language model, for each topic and contains the actions the chatbot is to perform to respond to an end user's input. An action is a step in the chatbot's execution. The dialog flow includes actions or operations, variables that store information gathered from the user during the conversation, conditional logic to route the conversation based on user input or variable values. As shown in FIG. 1, the chatbot designer generates a dialog flow 110 for the Credit Card Services topic that includes questions and conditions for follow-up questions. A more detailed description of the dialog flow is discussed below.

Once the topics, triggers and dialog flow are automatically generated, the chatbot designer generates a schema 112 to represent the execution structure and logical flow of the chatbot. As shown in FIG. 1, the schema of the Example Bank chatbot 112 is represented in a Yet Another Markup Language (YAML) format. The schema is then used in the execution of the chatbot to interact with the end user.

Attention now turns to a more detailed description of the system, device, and method for the automatic generation of a chatbot schema using machine learning.

### System

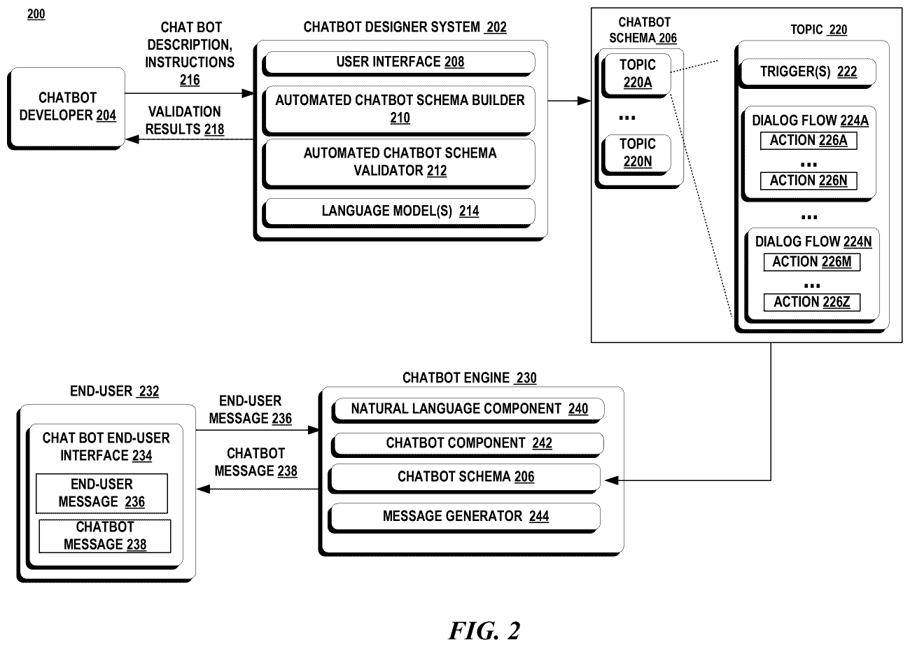

FIG. 2 represents an exemplary system 200 for automatically building and validating a chatbot schema. The chatbot designer system 202 is a computer program having executable components containing instructions that perform particular functions. In an aspect, the chatbot designer system 202 includes a user interface 208, an automated chatbot schema builder 210, an automated chatbot schema validator 212, and one or more language models 214. The user interface 208 interacts with a developer who is using the chatbot designer system 202 to develop a schema for the developer's chatbot. The developer uses the user interface 208 to input a description of the chatbot and the instructions of the chatbot 216. The automated chatbot schema builder 210 is a component that builds the schema through conversations with a language model. The automated chatbot schema validator 212 verifies the schema built by the automated chatbot schema builder 210 using simulated user queries generated by a language model that are executed by the chatbot. A more detailed description of each of the components of the chatbot designer system is discussed below.

The chatbot developer 204 inputs in the user interface a request 216 for the chatbot designer system to create a schema for an intended chatbot that the developer would like. The request 216 includes a natural language description of the chatbot and natural language instructions for a language model to understand the function of the intended chatbot and the chatbot's role. The automated chatbot schema builder 210 produces the chatbot schema 206 from the chatbot description and instructions 216 using language models and without user intervention.

In an aspect, the chatbot schema 206 includes topics 220A-220N (“220”) which are specific subjects within the chatbot's capabilities. Each topic 220 contains one or more triggers 222 where each trigger responds to a trigger event such as an end-user input (i.e., trigger phrase) or an action in a running dialog. A trigger 222 is associated with one or more dialog flows 224A-224N (“224) that perform one or more actions 226A-226Z (“226”) that respond to a trigger.

A trigger phrase is natural language text of the end-user input that is associated with a specific trigger. When a triggering event of a trigger occurs, the trigger causes some processing to occur. For instance, the trigger can be configured to launch a dialog flow or cause the chatbot to perform other operations in response to the triggering event it is configured for. A dialog flow consists of one or more actions which are steps in the execution of the chatbot. Examples of an action include “Begin a Dialog,” “End of Conversation,” “Question,” “ConditionGroup” and others. “Begin a Dialog” indicates the initiation of a conversation, “End of Conversation” indicates that the conversation is completed, “Question” causes a user prompt for information to be displayed to the end user, and “ConditionGroup” indicates conditions that need to be satisfied in order to proceed to the next action.

The automated chatbot schema validator 212 tests the operation of a chatbot. The validator 212 receives the description and instructions of a chatbot and uses a language model to generate one or more intents from the description and instructions. An intent refers to the underlying purpose of the end user's query which is essentially what the end user wants to achieve. The intent is crucial for the chatbot to identify the correct topic of the user's query. From the intents, the automated chatbot schema validator 212 uses the language model to generate simulated user queries. The chatbot is executed with a simulated user query to obtain the chatbot's response. The chatbot's response to the simulated query is analyzed by the automated chatbot schema validator to check for errors, such as the chatbot providing wrong information to an end user, the chatbot providing a generic answer that doesn't address the user query, the chatbot not following the schema, the chatbot not understanding the user's query, the chatbot not able to answer a user query that it is programmed to answer, the chatbot got into a loop and did not terminate normally, and the like. The errors are then presented to the developer for the developer to remedy.

Upon completion of the validation of the chatbot schema, the chatbot schema is utilized in a chatbot engine 230. The chatbot engine 230 is an executable program that uses the chatbot schema 206 to facilitate conversations with an end-user 232. The end-user 232 interacts with the chatbot engine 230 through a chatbot end-user interface 234. The end-user 232 sends, through the chatbot end-user interface 234, end-user messages 236 and receives, in the chatbot end-user interface 234, messages from the chatbot 238.

In an aspect, the chatbot engine 230 is a software program that runs the chatbot. The chatbot engine contains a number of source code components that perform a specific function. The chatbot engine includes a chatbot component 240, a natural language component 242, and a message generator 244. The natural language component 242 parses the natural language text in an end-user message to identify a trigger phrase. The chatbot component 240 parses the chatbot schema 206 for the topic associated with the trigger phrase and performs the actions of a dialog flow associated with the topic of the trigger phrase. The message generator 244 formats a chatbot message 238 responding to the end-user message 236.

The chatbot designer system 202 uses one or more language models 214. In an aspect, a language model is a deep learning model. Machine learning pertains to the use and development of computer systems that are able to learn and adapt without following explicit instructions by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, and visual data mapping.

Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks.

Neural transformers models are one type of deep learning model that utilize an attention mechanism. Attention directs the neural network to focus on a subset of features or tokens in an input sequence thereby learning different representations from the different positions of the tokens in an input sequence. The neural transformer model handles dependencies between its input and output with attention and without using recurrent neural networks (RNN) (e.g., long short-term memory (LSTM) network) and convolutional neural networks (CNN).

Examples of a language model include the encoder and generative neural transformer models with attention (i.e., encoder-decoder, decoder) offered by OpenAI (i.e., ChatGPT and Codex models), PaLM, Chinchilla, and the Bidirectional Encoder Representations from Transformers (BERT) offered by Google, the Gemini multi-modal models of Google, LLaMa by Meta, and the phi-3 models offered by Microsoft.

In an aspect, the language model 236 is a generative neural transformer model with attention (e.g., encoder-decoder, decoder). The language model 236 is hosted on an external server and accessed over a network through application programming interfaces (API). The input to the language model may be issued through HTTP-based Representational State Transfer (REST) APIs.

A REST API or web API is an API that conforms to the REST protocol. In the REST protocol, the remote server hosting the language model contains a publicly-exposed endpoint having a defined request and response structure. The chatbot designer issues web APIs containing an input to the remote server to instruct the large language model to perform the intended task for the given input.

It should be noted that the input to a language model may be in the form of a prompt which is a question or instruction given to a machine learning model to guide its response and tell it what task to perform. The prompt is the input that initiates the model's processing and determines the output that the model returns. The term prompt, when used with respect to input for a language model, refers to an input to a language model. However, it should be noted that there are other forms of input to the language model other than a prompt.

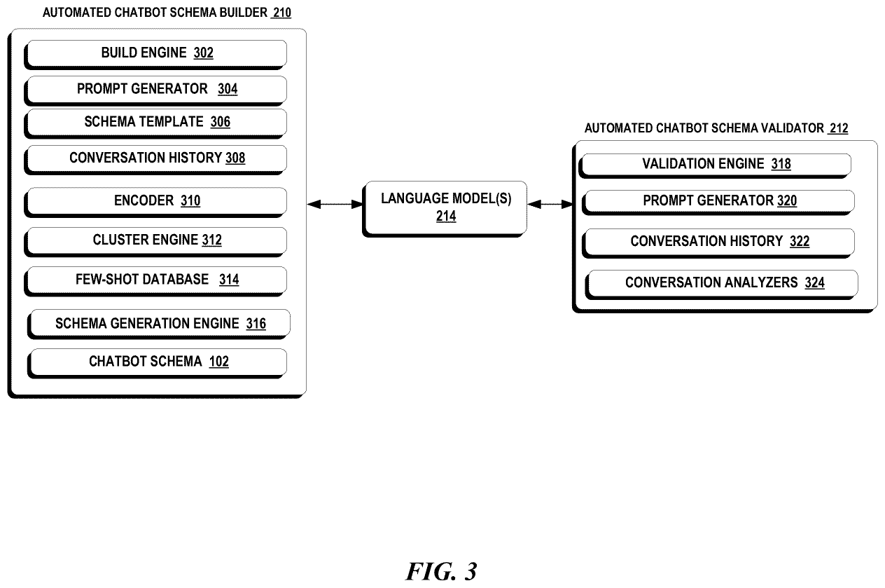

FIG. 3 illustrates exemplary components of the automated chatbot schema builder 210 and the automated chatbot schema validator 212. The automated chatbot schema builder 210 and the automated chatbot schema validator 212 interface with one or more language models 214 to build and test the chatbot schema.

In an aspect, the automated chatbot schema builder 210 includes a number of software components that perform a specific task to build the chatbot schema. In an aspect, there is a build engine 302, a prompt generator 304, a schema template 306, a conversation history 308, an encoder 310, a cluster engine 312, a few-shot database 314, a schema generation engine 316, and the chatbot schema 102.

The build engine 302 orchestrates the build process with the language models, the prompt generator 304 interacts with a language model 214 to input data to the language model and to obtain various data from the model response, the schema template 306 outlines the structure of the chatbot schema, and the conversation history 308 records the conversations with the language model including the inputs to the language model and the corresponding model responses. The schema generation engine assembles the topics, triggers, trigger phrases, and dialog flow into the chatbot schema. The few-shot database contains demonstrations of actions which are given to the language model to learn to generate an action from a simulated conversation which is described in more detail below.

The build engine 302 generates topics for the schema from clusters of simulated conversations. The simulated conversations are generated from the language model. The encoder 310 generates an embedding for each simulated conversation and the cluster engine 312 executes a clustering algorithm to form the clusters, where each cluster contains simulated conversations having closely matching embeddings. From each cluster, a select simulated conversation having an embedding that is the centroid of the cluster is selected to represent the cluster. The representative simulated conversation contains a sequence of user queries and corresponding chatbot responses that represent a dialog flow. The language model is then used to generate the intent for each representative simulated conversation and the intent becomes the topic of the schema.

The communications between the chatbot designer system and a language model are asynchronous where the language model does retain any state of the previous inputs and model responses. As such, each prompt to the language model and its model output is saved in chronological order in the conversation history 308. Each prompt issued to the language model includes the past conversations to provide the language model with the past context in order to continue the conversation.

As noted above, the encoder 310 and the cluster engine 312 are used in the detection of intents. The cluster engine 312 executes a clustering algorithm to aggregate similar simulated conversations into a cluster. The clustering algorithm uses the embeddings of each simulated conversation to form a cluster of simulated conversations having similar embeddings. The clustering algorithm uses a distance measure to determine the similarity of the embeddings of each simulated conversation. A single intent is used as a representative of each cluster which is then configured to become a topic and is described in more detail below.

In an aspect, the automated chatbot schema validator 212 includes a validation engine 318, a prompt generator 320, a conversation history 322, and conversation analyzers 324. The validation engine 318 controls the validation process which includes generating simulated user queries from the language model and executing the chatbot with the simulated user query. The prompt generator 320 formulates the inputs to the language model and the conversation history 322 is a chronological ordering of the model inputs and model responses. The conversation analyzers 222 analyze the responses from the chatbot's conversations to identify any performance improvements that can be made to the chatbot schema.

### Methods

Attention now turns to a description of the various exemplary methods that utilize the system and devices disclosed herein. Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

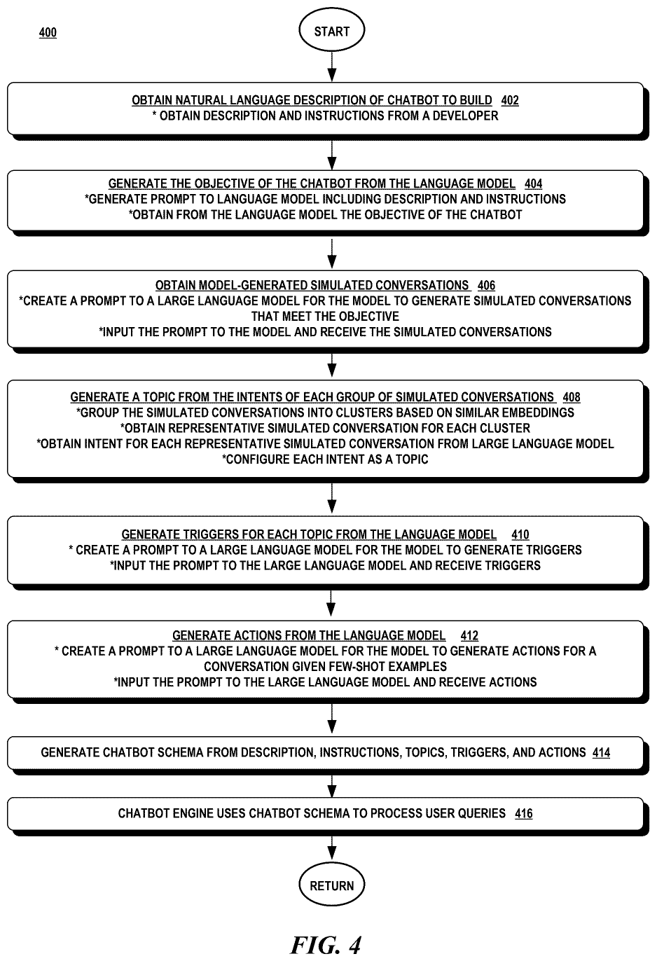

Turning to FIG. 4, there is shown an exemplary method of the automated chatbot schema builder 400. The method starts with a developer sending a request to the chatbot designer system that includes a description of the chatbot to build and an instruction for the chatbot (block 402).

A prompt or input is generated for a language model to identify an objective of the chatbot given the description and instructions (block 404). The chatbot designer system has to understand what the end user wants the chatbot to do in order to automatically build the desired chatbot schema. The objective provides this information. The objective is also included in the conversation history which is input to the language model in order to keep the model from drifting away from the task at hand and possibly hallucinating.

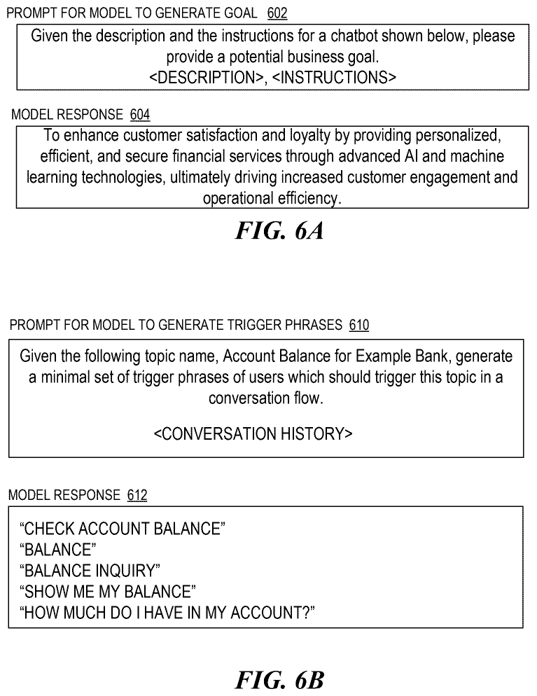

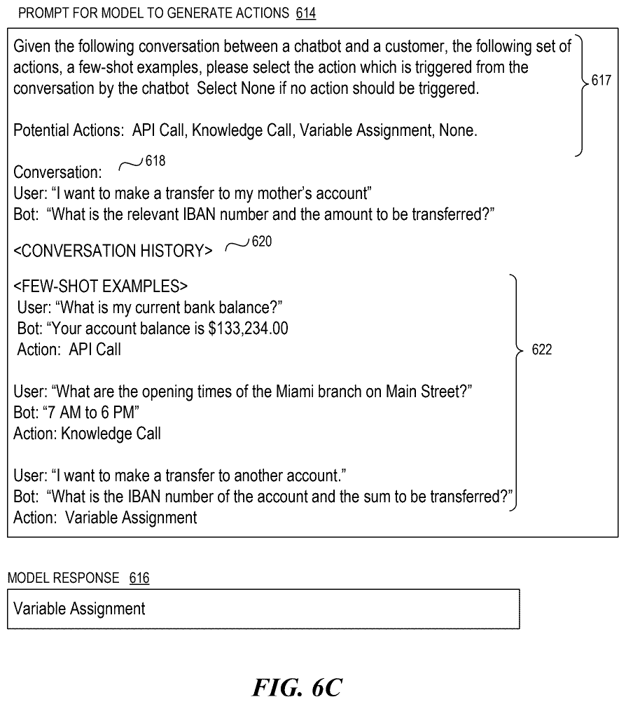

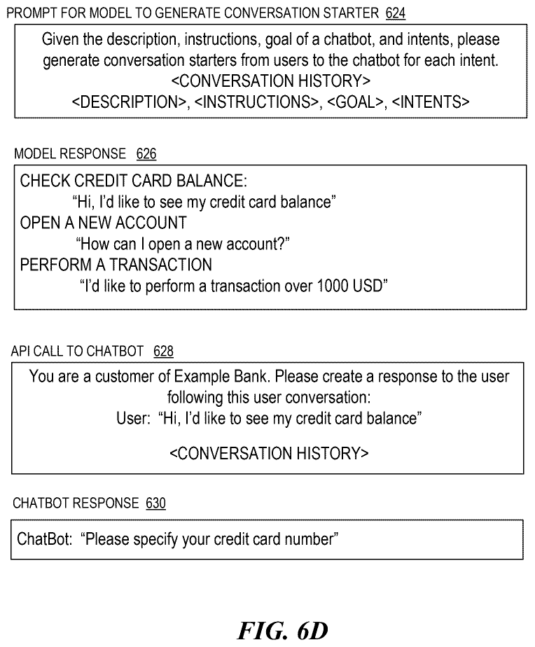

An exemplary prompt for the language model to generate the objective is shown in FIG. 6A for the exemplary banking chatbot schema shown in FIG. 1. The language model receives the prompt or input 602 which is input to the langrage model. The prompt includes instructions, the description, and the chatbot instructions. The language model responds with the following objective 604:

“To enhance customer satisfaction and loyalty by providing personalized, efficient, and secure financial services through advanced AI and machine learning technologies, ultimately driving increased customer engagement and operational efficiency.”

Next, simulated conversations are generated by the language model (block 406). A simulated conversation includes several pairs of user input and the corresponding chatbot response. A prompt is generated for the language model to generate the simulated conversations. The prompt includes model instructions, the conversation history, the description, the chatbot instructions, and the objective. The model responds with several simulated conversations formed in pairs, where each pair includes a user input and a chatbot response.

The simulated conversations are then aggregated into groups, where each group contains similar simulated conversations (block 408). An embedding is generated for each simulated conversation using an encoder. The similarity of the simulated conversations is based on closely-matching embeddings of each simulated conversation. An embedding is a learned vector representation for text-based tokens where tokens that have a common meaning have a common representation. A token is a smaller portion of a natural language text and can represent a word, a character, or sequence of characters. The embeddings for each simulated conversation are generated by an encoder, such as Word2Vec, Bidirectional Encoder Representations from Transformers (BERT), a neural encoder transformer model with attention, and the like.

The cluster engine executes a clustering algorithm to aggregate similar simulated conversations into a cluster. The clustering algorithm uses the embeddings of each simulated conversation to form a cluster of simulated conversations having similar embeddings. An exemplary clustering algorithm is the k-means clustering algorithm that partitions simulated conversations into k clusters by iteratively assigning the embeddings of the simulated conversations to the nearest centroid of a cluster. The clustering algorithm uses a distance measure determine the similarity of the embedding of each simulated conversation. The distance measures may include cosine similarity, Manhattan distance, Euclidean distance, and the like.

Within each cluster, a specific simulated conversation is selected to represent the cluster. In an aspect, the representative simulated conversation contains an embedding value that is the centroid of the cluster. The representative simulated conversation contains a sequence of user queries and corresponding chatbot responses that represents a dialog flow.

A language model is then used to generate the intent for each representative simulated conversation. A prompt is generated for the language model to generate the intent where the prompt includes instructions, the conversation history, the description, the chatbot instructions, the objective, and the simulated conversation for which an intent is to be generated (block 408). The language model responds with an intent for each cluster of similar simulated conversations (block 408). The intent of each representative simulated conversation is then considered a topic of the chatbot schema (block 408). For example, the topics for the banking example of FIG. 1, may include “ACCOUNT BALANCES”, “BILL PAYMENTS,” “BUDGETING AND SAVINGS,” “CREDIT CARD SERVICES”, “FUND TRANSFERS,” “GOODBYE,” “GREETING,” “INVESTMENT ADVICE,” LOAN APPLICATION,” “SAVINGS CALCULATOR,” “START OVER,” “THANK YOU,” and “TRANSACTION HISTORY.”

Next, the build engine 302 generates triggers for each topic using the language model (block 410). The prompt generator generates an input to the language model for the language model to generate trigger phrases or events for each topic. For example, as shown in FIG. 6B, the prompt generator builds a prompt including instructions, the conversation history, and the topic for the language model to generate trigger phrases for the topic name, Account Balance for Example Bank 610. The model responds with the trigger phrases “CHECK ACCOUNT BALANCE”, “BALANCE INQUIRY”, “SHOW ME MY BALANCE” and “HOW MUCH DO I HAVE IN MY ACCOUNT?” 612.

The build engine 302 then generates actions for each topic using the language model (block 412). An input is generated for the language model to generate an action for a segment of a simulated conversation. The segment includes a user input and the corresponding chatbot response. In this prompt, the prompt includes a few-shot examples which demonstrate actions that correspond to a segment of a sample conversation. The language model responds with the action. The process is repeated for each user input and chatbot response in the simulated conversation until a sequence of actions is generated. The sequence of actions is considered the dialog flow.

For example, FIG. 6C illustrates an exemplary prompt 614 and model response 616 used to generate an action for a simulated conversation that includes the user input, “I want to make a transfer to my mother's account,” and the chatbot response, “What is the relevant IBAN number and the amount to be transferred?” The input 614 includes instructions 617, the simulated conversation 618, the conversation history 620, and the few-shot examples 622. The model responds with the action of “Variable Assignment” 616.

The build engine 302 assembles the data output from the various model responses into a predetermined schema format (block 414). In an aspect, a schema generation engine 316 uses the schema template 306 to format the data generated by the language model in a desired schema format. The schema format may be implemented as a JavaScript Object Notation (JSON) file or a Yet Another Markup Language (YAML) file.

The chatbot schema 102 may then be used in a chatbot engine 230 (block 416). A chatbot engine 230 uses the chatbot schema to understand the user input and to follow the dialog flows when processing the user input. The chatbot schema 102 guides the behavior of the chatbot engine 230 in order to avoid security issues or vulnerabilities with the chatbot.

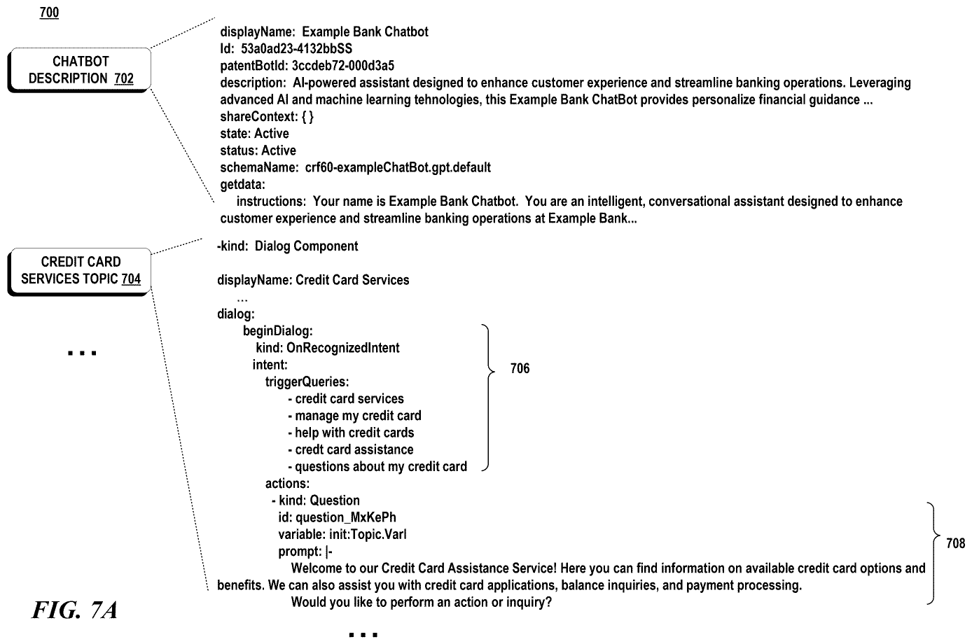

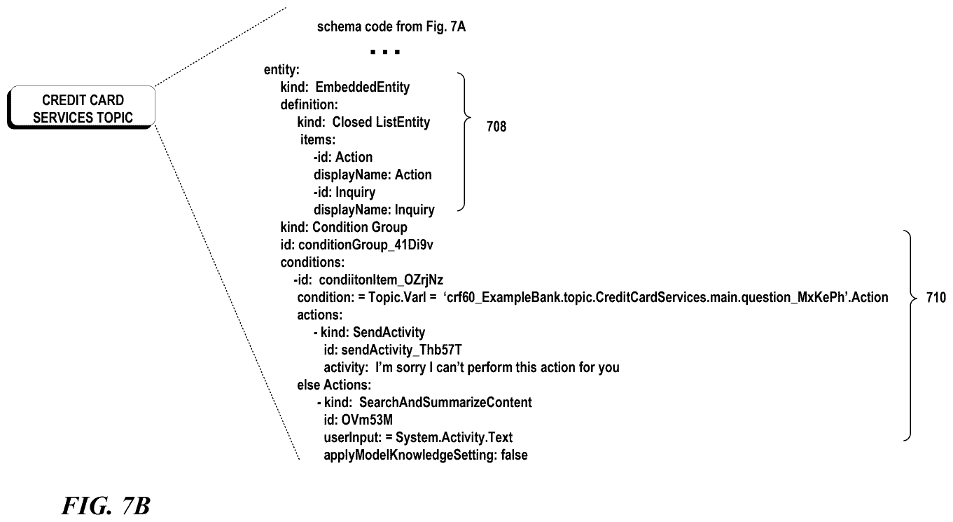

Turning to FIGS. 7A and 7B, there is shown a portion of an exemplary chatbot schema 700. The chatbot schema is composed of nodes including a first node 702 that describes the chatbot and where each subsequent node pertains to a topic 704. FIG. 7A shows a portion of the chatbot schema for the banking chatbot schema. The first node 702 describes the chatbot and the second node 704 pertains to the Credit Card Services topic. There are additional sections for each topic although not shown.

The node 704 contains the trigger phrases that activate the actions of the topic. As shown in FIG. 7A, the trigger phrases for the Credit Card Services topic 706 include “credit card services,” “manage my credit card,” “help with credit cards,” “credit card assistance,” and “questions about my credit card.”

The first action that occurs when a trigger phrase is received is the Question action 708. The Question action causes the following message and question to be output to the end user, “Welcome to our Credit Card Assistance Service! Here you can find information on available credit card options and benefits. We can also assist you with credit card applications, balance inquiries, and payment processing. Would you like to perform an action or inquiry?”

The EmbeddedEntity action 708 is used when the requested information is contained in an end user input. The ConditionGroup action 710 indicates conditions that activate the next action. For example, if the end user response does not respond to the question posed to the end user, the chatbot responds with the message “I'm sorry I can't perform this action for you.” Otherwise, the chatbot activates the action SearchAndSummarizeContent to obtain the data needed to respond to the end user.

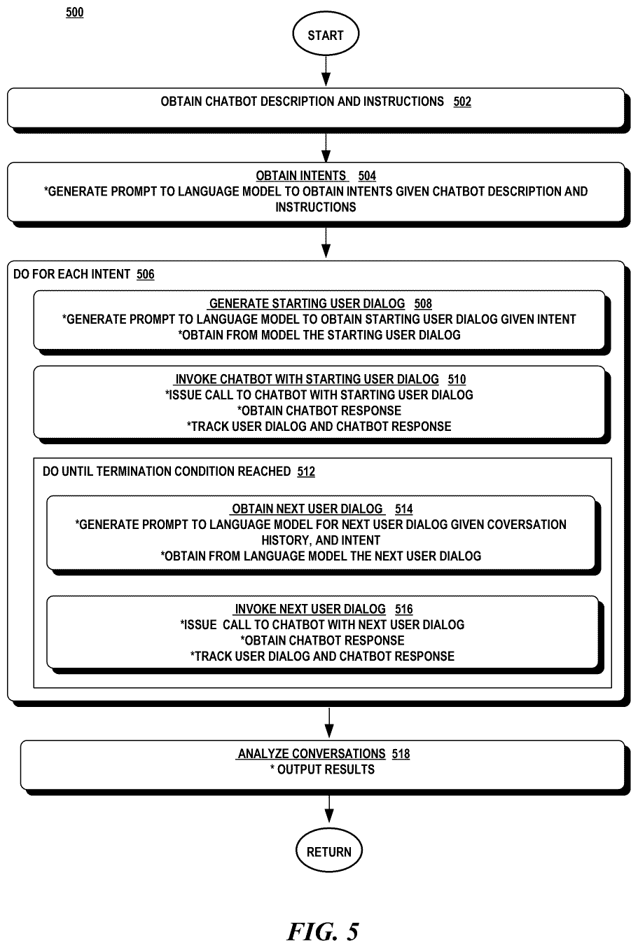

Turning now to FIG. 5, there is shown an exemplary method for validating a chatbot 500. In an aspect, the validation engine 318 receives a description and chatbot instructions of a chatbot schema to validate. The chatbot description and chatbot instructions may come from a developer or the validation engine 318 extracts the description and chatbot instructions from an existing schema (block 502).

Next, the validation engine 318 generates intents obtained from the language model (block 504). The prompt generator 320 constructs a prompt which is input to the language model to obtain the intents. The prompt includes model instructions, the description, and the chatbot instructions for the language model to generate a number of intents.

For each intent, the validation engine 318 generates a simulated user input from the language model (block 508). The language model generates a starting user dialog which is a simulated user query that is given to the chatbot to obtain the chatbot's response (block 510).

For example, turning to FIG. 6D, there is shown an exemplary prompt to the language model for a starting user dialog 624. The prompt 624 includes the model instructions, a conversation history, the description, the chatbot instructions, and intents. The model response 626 includes a simulated user input for each of the intents. The intents include “CHECK CREDIT CARD BALANCE,” “OPEN A NEW ACCOUNT,” and “PERFORM A NEW TRANSACTION.” For the CHECK CREDIT CARD BALANCE intent, the starting user dialog is “Hi, I'd like to see my credit card balance.” The validation engine 318 then invokes an API call to the chatbot with this starting user dialog 628 and obtains the chatbot's response 630 which is a question for the end user's credit card number.

The conversation continues with the validation engine 318 generating a next user dialog (block 514) which is then input into the chatbot (block 516) until a termination condition occurs (block 512). The termination condition may be a pre-determined number of iterations. The validation engine 318 tracks the next user dialog and the corresponding chatbot responses (block 516).

The machine-generated user dialog (i.e., starting user dialog and next user dialog) and the corresponding chatbot responses are then analyzed by one or more conversation analyzers 324 (block 518). In an aspect, the conversation analyzers 324 include natural language processing tools that analyze the grammar of a chatbot response, wordiness of the chatbot response and the chatbot's understanding of a simulated user query. Other tools are used to determine whether the chatbot's response adheres to the chatbot schema or goes off track conversing on an unrelated topic. The errors are then output to the developer to remedy (block 518).

### Exemplary Operating Environment

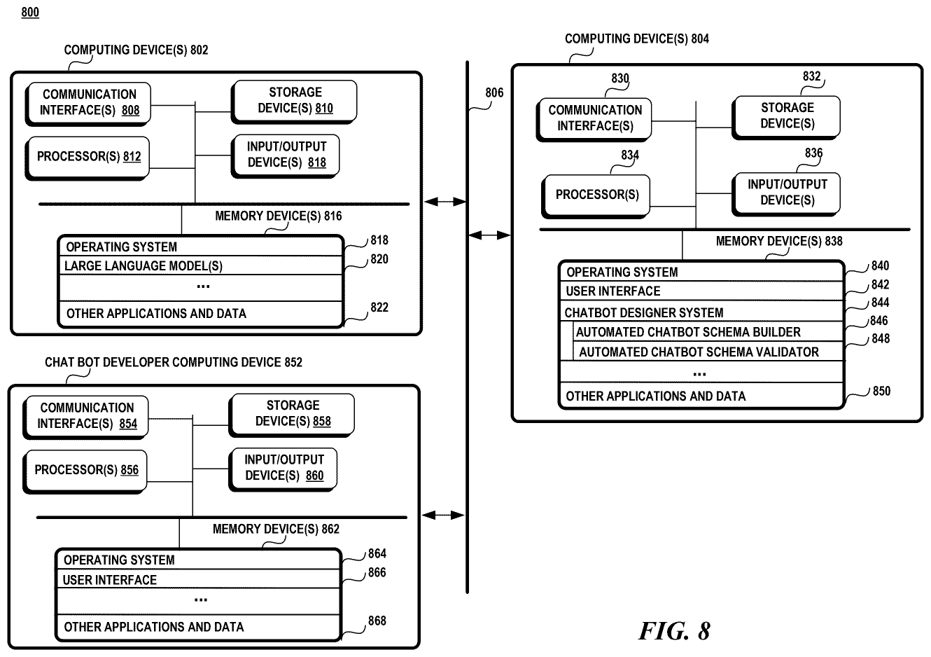

Attention now turns to a discussion of an exemplary operating environment. FIG. 8 illustrates an exemplary operating environment 800 in which one or more computing devices 802 are used to host one or more language models 820, one or more computing devices 804 are used to host the chatbot designer system 844, and another computing device 852 is used to host the chatbot developer. However, it should be noted that the aspects disclosed herein are not constrained to any particular configuration of devices. In another aspect, a single computing device may host the large language model, the chatbot designer system, and the chatbot developer.

A computing device 802, 804, 852 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 400 may be configured in a network environment, a distributed environment, a multi-processor environment, or a stand-alone computing device having access to remote or local storage devices.

The computing device 802, 804, 852 may include one or more processors 812, 834, 856, one or more communication interfaces 808, 830, 854, one or more hardware storage devices 810, 832, 858, one or more input/output devices 814, 836, 860, and one or more memory devices 816, 838, 862. A processor 812, 834, 856 may be any commercially available or customized processor and may include dual microprocessors and multi-processor architectures. A communication interface 808, 830, 854 facilitates wired or wireless communications between the computing devices and other devices. A hardware storage device 810, 832, 858 may be a computer-readable medium that does not contain propagating signals, such as modulated data signals transmitted through a carrier wave. Examples of a hardware storage device 810, 832, 858 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple hardware storage devices 810, 832, 858 in a computing device 802, 804, 852. The input/output devices 814, 836, 860 may include a keyboard, mouse, pen, voice input device, touch input device, display, speakers, printers, etc., and any combination thereof.

A memory device or memory 816, 838, 862 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 816, 838, 862 may also include one or more external hardware storage devices or remotely located hardware storage devices that do not pertain to propagated signals, such as modulated data signals transmitted through a carrier wave.

The memory device 816, 838, 862 may contain instructions, components, and data. A component is a software program having executable instructions that perform a specific function and is otherwise known as a module, program, component, engine and/or application. The memory device 816 may include an operating system 818, one or more large language models 820, and other applications and data 822. The memory device 838 may include an operating system 840, a user interface 842, the chatbot designer system 844 including the automated chatbot schema builder 846, the automated chatbot schema validator 848, and other applications and data 850. The memory device 862 may include an operating system 864, a user interface 866, and other applications and data 868.

The computing devices are communicatively coupled via a network 806. The network 806 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 806 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### Technical Effect

Aspects of the subject matter disclosed herein pertain to the technical problem of automatically generating a chatbot schema from a natural language description. The technical features associated with addressing this problem are the machine-generated simulated conversations from which topics, trigger phrases and dialog flows are generated. The technical effect achieved is the construction of a chatbot schema that provides a chatbot application with enhanced accuracy without undue increased computational burden.

The technique disclosed herein is advantageous over prior solutions that relied on a developer's skill in chatbot development and knowledge of the business application. At times, this resulted in a chatbot producing poor responses to a user's input since the responses were dependent on the developer's chatbot development skill and business acumen. The use of the machine learning models generates a more robust chatbot schema having been trained on a large corpus of data thereby providing enhanced accuracy without undue increased computational burden.

In addition, the chatbot schema provides enhanced security measures for the chatbot since the schema controls the behavior of the chatbot. The schema restricts the chatbot from performing operations that the chatbot is not designed for. The schema prevents the chatbot from releasing the end user's private data and engaging in conversations outside of the objective of the chatbot.

One of ordinary skill in the art understands that the technical effects are the purpose of a technical embodiment. Operations used to obtain the topics, simulated conversations, trigger phrases and dialog flows in the manner disclosed is understood herein as inherently digital. The human mind cannot interface directly with a CPU or network interface card, or other processor, or with RAM or other digital storage, to read or write the necessary data and perform the necessary operations in the manner disclosed herein.

The embodiments are also presumed to be capable of operating at scale, within tight timing constraints in production environments, or in testing labs for production environments as opposed to being mere thought experiments.

### Conclusion

A system is disclosed comprising: a processor; and a memory that stores a program that is configured to be executed by the processor. The program comprises instructions to perform acts that: obtain a description of a chatbot to build; access a language model to generate an objective of the chatbot given the description of the chatbot; cause the language model to generate a plurality of simulated conversations between an end user and the chatbot that achieve the objective; generate at least one topic from the plurality of simulated conversations by: clustering the plurality of simulated conversations having closely-matching embeddings into at least one cluster; causing the language model to generate an intent for the at least one cluster; and configuring the intent as the at least one topic; cause the language model to generate a trigger for the at least one topic; cause the language model to generate a dialog flow for the at least one topic, wherein the dialog flow comprises actions that generate a response to an end user input that pertains to the at least one topic; and generate a chatbot schema comprising the at least one topic, the trigger phrase for the at least one topic, and the dialog flow of the at least one topic.

In an aspect, the chatbot schema causes the chatbot to identify the at least one topic when the trigger phrase appears in the end user input and to generate a response to the end user input based on the actions of the at least one topic.

In an aspect, the program comprises further instructions to perform acts that: group the plurality of simulated conversations into a plurality of clusters, wherein a cluster comprises similar simulated conversations.

In an aspect, the program comprises further instructions to perform acts that: select one of the similar simulated conversations of a select cluster to represent the select cluster.

In an aspect, the program comprises further instructions to perform acts that: cause the language model to generate an intent for the select cluster, wherein the language model is given the select one of the similar simulated conversations for the select cluster; and configure the intent for the select cluster as the at least one topic for the chatbot schema.

In an aspect, the program comprises instructions to perform acts that: cause the language model to generate a simulated user input given the description of the chatbot; and execute the chatbot with the simulated user input to generate a chatbot response.

In an aspect, the program comprises further instructions to perform acts that: validate the chatbot response for an error, wherein the error comprises the chatbot response providing wrong information, the chatbot response providing a generic answer that does not address a user query, the chatbot response not following the schema, or the chatbot response did not understand the user query.

A computer-implemented method is disclosed comprising: receiving a description of a chatbot to build; causing a language model to generate an objective of the chatbot given the description of the chatbot to build; causing the language model to generate a plurality of simulated conversations between an end user and the chatbot that achieves the objective; grouping the plurality of simulated conversations into a plurality of clusters, wherein each cluster comprises simulated conversations having closely-matching embeddings; causing the language model to generate an intent for each cluster, wherein the language model is given a select one of the simulated conversations of each cluster; generating a topic from the intent output by the language model; causing the language model to generate a trigger phrase for the topic; causing the language model to generate a dialog flow for the topic, wherein the dialog flow comprises actions that generate a response to an end user input when the trigger phrase for the topic appears in a user input, wherein the language model is given the description of the chatbot to build, the objective of the chatbot to build, and the topic; and generating a chatbot schema comprising the topic, the trigger phrase for the topic, and the dialog flow of the topic, wherein the chatbot schema is used in execution of the chatbot along the dialog flow of the topic to respond to the user input when the trigger phrase for the topic appears in the user input.

In an aspect, the chatbot schema is used in execution of the chatbot to cause the chatbot to respond to the user input.

In an aspect, the method further comprises: causing the language model to generate an intent given the description of the chatbot to build; and causing the language model to generate a starting dialog given the intent, wherein the starting dialog comprises a simulated user query.

In an aspect, the method further comprises: invoking the chatbot with the starting dialog; and obtaining from the chatbot a first response to the starting dialog.

In an aspect, the method further comprises: validating the first response for an error where the chatbot fails to follow the chatbot schema.

In an aspect, the method further comprises: causing the language model to generate a next user dialog given the starting dialog and first model response, wherein the next user dialog comprises a second user query; invoking the chatbot with the next user dialog; and obtaining from the chatbot a second response to the next user dialog.

In an aspect, the method further comprises: validating the second response for an error where the chatbot response provides an answer that does not address the second user query.

In an aspect, the method further comprises: validating the second response for an error where the chatbot response fails to answer the second user query.

A hardware storage device is disclosed having stored thereon computer executable instructions that are structured to be executable by a processor of a computing device to thereby cause the computing device to perform actions that: access a description of a chatbot to build; cause a language model to generate an objective of the chatbot given the description of the chatbot; cause the language model to generate a plurality of simulated conversations between an end user and the chatbot that achieve the objective; group the plurality of simulated conversations into a plurality of clusters, wherein each cluster comprises simulated conversations having closely-matching embeddings; cause the language model to generate an intent for each cluster of the plurality of clusters, wherein the language model is given a select one of the simulated conversations of each cluster of the plurality of clusters; configure each intent of each cluster of the plurality of clusters as a topic; cause the language model to generate a trigger for a select topic, wherein the language model is given the select topic; cause the language model to generate a dialog flow for the select topic, wherein the dialog flow comprises actions that generate a response to an end user input, wherein the language model is given a few-shot examples that demonstrate a mapping of a sampled user input into a corresponding dialog flow; and format a chatbot schema comprising the select topic, the trigger for the select topic, and the dialog flow of the select topic, wherein the chatbot schema is used in execution of the chatbot along the dialog flow of the at select topic to respond to the end user input.

In an aspect, the hardware storage device has stored thereon computer executable instructions that are structured to be executable by a processor of a computing device to thereby cause the computing device to perform actions that: execute the chatbot schema in a chatbot to cause the chatbot to identify the at least one topic when the trigger phrase appears in the end user input and to generate a response to the end user input based on the actions of the dialog flow.

In an aspect, the hardware storage device has stored thereon computer executable instructions that are structured to be executable by a processor of a computing device to thereby cause the computing device to perform actions that: cause the language model to generate a starting dialog, wherein the starting dialog comprises a simulated user query; invoke the chatbot with the starting dialog; and obtain from the chatbot a first response to the starting dialog.

In an aspect, the hardware storage device has stored thereon computer executable instructions that are structured to be executable by a processor of a computing device to thereby cause the computing device to perform actions that: cause the language model to generate a next user dialog given the starting dialog and first model response, wherein the next user dialog comprises a second user query; invoke the chatbot with the next user dialog; and obtain from the chatbot a second response to the second user query.

In an aspect, the hardware storage device has stored thereon computer executable instructions that are structured to be executable by a processor of a computing device to thereby cause the computing device to perform actions that: validate the first response and second response for an error where the first response or the second response fails to follow the chatbot schema.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, the techniques disclosed herein may be applied to any data included in a prompt and is not limited to ordering the in-context data.

It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

What is claimed:

1. A system comprising:
a processor; and
a memory that stores a program that is configured to be executed by the processor, wherein the program comprises instructions to perform acts that:
obtain a description of a chatbot to build;
access a language model to generate an objective of the chatbot given the description of the chatbot;
cause the language model to generate a plurality of simulated conversations between an end user and the chatbot that achieve the objective;
generate at least one topic from the plurality of simulated conversations by:
clustering the plurality of simulated conversations having closely-matching embeddings into at least one cluster;
causing the language model to generate an intent for the at least one cluster; and
configuring the intent as the at least one topic;
cause the language model to generate a trigger for the at least one topic;
cause the language model to generate a dialog flow for the at least one topic, wherein the dialog flow comprises actions that generate a response to an end user input that pertains to the at least one topic; and
generate a chatbot schema comprising the at least one topic, the trigger phrase for the at least one topic, and the dialog flow of the at least one topic.

2. The system of claim 1, wherein the chatbot schema causes the chatbot to identify the at least one topic when the trigger phrase appears in the end user input and to generate a response to the end user input based on the actions of the at least one topic.

3. The system of claim 1, wherein the program comprises further instructions to perform acts that:
group the plurality of simulated conversations into a plurality of clusters, wherein a cluster comprises similar simulated conversations.

4. The system of claim 3, wherein the program comprises further instructions to perform acts that:
select one of the similar simulated conversations of a select cluster to represent the select cluster.

5. The system of claim 4, wherein the program comprises further instructions to perform acts that:
cause the language model to generate an intent for the select cluster, wherein the language model is given the select one of the similar simulated conversations for the select cluster; and
configure the intent for the select cluster as the at least one topic for the chatbot schema.

6. The system of claim 1, wherein the program comprises instructions to perform acts that:
cause the language model to generate a simulated user input given the description of the chatbot; and
execute the chatbot with the simulated user input to generate a chatbot response.

7. The system of claim 6, wherein the program comprises further instructions to perform acts that:
validate the chatbot response for an error, wherein the error comprises the chatbot response providing wrong information, the chatbot response providing a generic answer that does not address a user query, the chatbot response not following the schema, or the chatbot response did not understand the user query.

8. A computer-implemented method comprising:
receiving a description of a chatbot to build;
causing a language model to generate an objective of the chatbot given the description of the chatbot to build;
causing the language model to generate a plurality of simulated conversations between an end user and the chatbot that achieves the objective;
grouping the plurality of simulated conversations into a plurality of clusters, wherein each cluster comprises simulated conversations having closely-matching embeddings;
causing the language model to generate an intent for each cluster, wherein the language model is given a select one of the simulated conversations of each cluster;
generating a topic from the intent output by the language model;
causing the language model to generate a trigger phrase for the topic;
causing the language model to generate a dialog flow for the topic, wherein the dialog flow comprises actions that generate a response to an end user input when the trigger phrase for the topic appears in a user input, wherein the language model is given the description of the chatbot to build, the objective of the chatbot to build, and the topic; and
generating a chatbot schema comprising the topic, the trigger phrase for the topic, and the dialog flow of the topic,
wherein the chatbot schema is used in execution of the chatbot along the dialog flow of the topic to respond to the user input when the trigger phrase for the topic appears in the user input.

9. The computer-implemented method of claim 8, wherein the chatbot schema is used in execution of the chatbot to cause the chatbot to respond to the user input.

10. The computer-implemented method of claim 8, further comprising:
causing the language model to generate an intent given the description of the chatbot to build; and
causing the language model to generate a starting dialog given the intent, wherein the starting dialog comprises a simulated user query.

11. The computer-implemented method of claim 10, further comprising:
invoking the chatbot with the starting dialog; and
obtaining from the chatbot a first response to the starting dialog.

12. The computer-implemented method of claim 11, further comprising:
validating the first response for an error where the chatbot fails to follow the chatbot schema.

13. The computer-implemented method of claim 11, further comprising:
causing the language model to generate a next user dialog given the starting dialog and first model response, wherein the next user dialog comprises a second user query;
invoking the chatbot with the next user dialog; and
obtaining from the chatbot a second response to the next user dialog.

14. The computer-implemented method of claim 13, further comprising:
validating the second response for an error where the chatbot response provides an answer that does not address the second user query.

15. The computer-implemented method of claim 13, further comprising:
validating the second response for an error where the chatbot response fails to answer the second user query.

16. A hardware storage device having stored thereon computer executable instructions that are structured to be executable by a processor of a computing device to thereby cause the computing device to perform actions that:
access a description of a chatbot to build;
cause a language model to generate an objective of the chatbot given the description of the chatbot;
cause the language model to generate a plurality of simulated conversations between an end user and the chatbot that achieve the objective;
group the plurality of simulated conversations into a plurality of clusters, wherein each cluster comprises simulated conversations having closely-matching embeddings;
cause the language model to generate an intent for each cluster of the plurality of clusters, wherein the language model is given a select one of the simulated conversations of each cluster of the plurality of clusters;
configure each intent of each cluster of the plurality of clusters as a topic;
cause the language model to generate a trigger for a select topic, wherein the language model is given the select topic;
cause the language model to generate a dialog flow for the select topic, wherein the dialog flow comprises actions that generate a response to an end user input, wherein the language model is given a few-shot examples that demonstrate a mapping of a sampled user input into a corresponding dialog flow; and
format a chatbot schema comprising the select topic, the trigger for the select topic, and the dialog flow of the select topic,
wherein the chatbot schema is used in execution of the chatbot along the dialog flow of the at select topic to respond to the end user input.

17. The hardware storage device of claim 16 having stored thereon computer executable instructions that are structured to be executable by a processor of a computing device to thereby cause the computing device to perform actions that:
execute the chatbot schema in a chatbot to cause the chatbot to identify the at least one topic when the trigger phrase appears in the end user input and to generate a response to the end user input based on the actions of the dialog flow.

18. The hardware storage device of claim 16 having stored thereon computer executable instructions that are structured to be executable by a processor of a computing device to thereby cause the computing device to perform actions that:
cause the language model to generate a starting dialog, wherein the starting dialog comprises a simulated user query;
invoke the chatbot with the starting dialog; and
obtain from the chatbot a first response to the starting dialog.

19. The hardware storage device of claim 18 having stored thereon computer executable instructions that are structured to be executable by a processor of a computing device to thereby cause the computing device to perform actions that:
cause the language model to generate a next user dialog given the starting dialog and first model response, wherein the next user dialog comprises a second user query;
invoke the chatbot with the next user dialog; and
obtain from the chatbot a second response to the second user query.

20. The hardware storage device of claim 16 having stored thereon computer executable instructions that are structured to be executable by a processor of a computing device to thereby cause the computing device to perform actions that:
validate the first response and second response for an error where the first response or the second response fails to follow the chatbot schema.
